(19) United States
(12) Patent Application Publication
(10) Pub. No.: US 2003/0023966 A1
(43) Pub. Date: Jan. 30, 2003

(54) Method of software installation and updating firmware, recording and reading device, and recording medium therefor

(75) Inventors: Kikuo Shimizu, Hitachinaka (JP); Shinichi Arai, Odawara (JP); Jiro Azuma, Hitachinaka (JP); Atsushi Fuchiwaki, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 10/120,963

(22) Filed: Apr. 10, 2002

(30) Foreign Application Priority Data
Jul. 30, 2001 (JP) 2001-228867

(51) Int. Cl. G06F 9/445

(52) U.S. Cl. 717/175

(57) ABSTRACT

When installing software in a user's computer using a medium distributed from a supplier, an install limited count, which limits the number of times installation can occur, is recorded in a user-inaccessible area of a removable recording medium. In addition, an install count, which indicates the number of times the software installation has been executed and which is updated when the software installation is executed, is also recorded in the user-inaccessible area of the removable recording medium. Every time the software is installed, the install count is compared with the install limited count to prevent the software installation from being executed more than the number of times set by the install limited count.

### CROSS-REFERENCES TO RELATED APPLICATIONS

Not Applicable.

### STATEMENT AS TO RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK

Not Applicable.

### BACKGROUND OF THE INVENTION

The present invention relates to a software installation method or a firmware updating method.

A conventional method for supplying software is designed such that software, which will be installed in a computer, and a user code, which is a type of key for completing the installation operation, are given so that the installation cannot be completed without the user code. Multiple copies of software can also be purchased; however, in this case, the same user code is used even when the software is installed in another computer. Under present circumstances, the number of copies of installed software is actually managed based on judgment on the user side.

Such a method enables a user who has obtained a user code to execute software installation in multiple computers. Even when multiple copies of software are purchased, it is possible to execute software installation beyond a limit, that is, beyond the number of copies of the purchased software. To solve the problem of software being installed more than the limited number of times allowed, the following methods have been proposed:

Method A: In this known method, when software is initially installed, a subsequent installation is limited by writing data on the provided medium. For example, at the time of distribution by a supplier, a software main body and an unlock key are written on a recordable disk such as a floppy disk. After executing the installation, this unlock key is rewritten or deleted to prevent installation using this disk again.

Method B: Japanese Patent Application Laid-Open No. Hei 10-198569, describes the following method: transmitting user information about a user's computer to a host computer connected via a mutual communication means; and, on the basis of the user's computer information, receiving an unlock key from the host computer, the key being data for continuing installation. In this method, the unlock key is generated on the basis of information pertaining to a user's computer. Therefore, it is not possible to install the software in another computer using the same unlock key.

However, the above methods have the following problems. In method A, a software supply medium is required to be a recordable removable medium such as a floppy disk. If a read-only medium such as a CD-ROM, now the most widely used medium, is used, it is not possible to rewrite or delete the unlock key. In addition, if a medium having a small amount of storage capacity such as a floppy disk is used, installed software is limited in size. Moreover, if the software main body and the unlock key, which are recorded on this recording medium, are copied to another recording medium before the software installation, the copied medium can be used for installing the software in another computer, even if the original distributed medium cannot be used. This sidestepping enables unlimited software installation.

In addition, method B has the following problem: A computer on which the software is to be installed must be connected to a host computer via a mutual communication means, with the result that installation cannot be executed in a stand-alone computer.

### SUMMARY OF THE INVENTION

The present invention provides a method for preventing unauthorized use, and, thereby, unauthorized installations, by limiting the number of installations from a single copy of the software to the number authorized by a software supplier. The method further ensures that even if a supplied recording medium is copied prior to a first use, installation cannot be executed from the copied medium.

The recording medium is configured to comprise the following areas: an area in which software to be installed in a computer is recorded; and a user-inaccessible area where an “install limited count”, which indicates the number of times software installation is allowed, is written beforehand, and where an “install count”, which is updated every time software installation is executed, is recorded. In addition, the software can be installed in a computer using that recording medium, on which an installation execution program is also recorded, said installation execution program comprising: a portion for determining software installation execution, which compares the install count with the install limited count; and an installation execution portion for executing installation of the software in a computer if the install count is smaller than the install limited count.

During software installation, the install count and the install limited count recorded on the recording medium are compared. If the install count is smaller than the install limited count, the software is installed in the recording device. In this example, after the installation is completed, the install count is increased by one.

A computer, in which software is installed, is configured to include the following: a recording and reading device that can read information written onto the recording medium; a main storage for temporarily storing an installation execution program that has been read by the recording and reading device; a secondary memory device for storing software to be installed; and a central processing unit for controlling these components. The central processing unit executes the installation execution program stored in main storage, and compares an install count with an install limited count. If the install count is smaller than the install limited count, the central processing unit reads the software to be installed from the recording medium, controls the recording and reading device so that the install count recorded on the recording medium is updated, and controls the secondary memory so that the read software is stored.

In addition, the recording and reading device in the computer may also contain a part or all of the installation execution program. In that case, the recording and reading device is configured to have a means for performing the following: when the software recorded on the recording medium is being installed in an outside device such as a hard disk in a different computer, reading the install count indicating the number of times the software has been installed, and the install limited count indicating the number of times the installation is allowed, both of which have been written beforehand in a user-inaccessible area of the recording medium; reading the software from the recording medium, if the install count is smaller than the install limited count,; and updating the install count every time the software is installed in an outside device, and then writing the install count into a user-inaccessible area of the recording medium.

Moreover, it is also possible to use the method described above to update firmware in the recording and reading device. In this case, “firmware would take the place of “software,” and an “update” would take the place of the “installation,” with everything else being the same.

### BRIEF DESCRIPTION OF THE DRAWINGS

FIG. 1 is a flowchart illustrating software installation steps according to an embodiment of the present invention;

FIG. 2 is a diagram illustrating a configuration of a removable recording medium, which is distributed by a software supplier, according to an embodiment of the present invention;

FIG. 3 illustrates a configuration of a computer according to an embodiment of the present invention;

FIG. 4 is a diagram illustrating a configuration of an optical disk device according to an embodiment of the present invention;

FIG. 5 is a diagram illustrating a method for updating an install count in a recording medium according to an embodiment of the present invention;

FIG. 6 is a diagram illustrating a configuration of a removable recording medium, which is distributed by a software supplier, according to an embodiment of the present invention;

FIG. 7 is a flowchart illustrating software installation steps according to an embodiment of the present invention;

FIG. 8 is a diagram illustrating a configuration of a removable recording medium, which is distributed by a firmware supplier, according to an embodiment of the present invention;

FIG. 9 is a flowchart illustrating firmware update steps according to an embodiment of the present invention;

FIG. 10 is a diagram illustrating a configuration of a removable recording medium, which is distributed by a firmware supplier, according to an embodiment of the present invention;

FIG. 11 is a flowchart illustrating firmware update steps according to an embodiment of the present invention; and

FIG. 12 is a diagram illustrating a writing position of installation management information in a removable recording medium according to an embodiment of the present invention.

### DETAILED DESCRIPTION OF THE INVENTION

First, an outline of a method for preventing unauthorized installation of software according to the present invention will be described.

When installing software in a user's computer using a medium distributed by a supplier, it is possible to limit installation by the following steps: in addition to the software information recorded on a distribution medium, writing an install limited count into a user-inaccessible area of a removable recording medium prior to distribution; writing an install count, which indicates the number of times the installation has been executed, and which is updated every time the software installation is executed, into the user-inaccessible area of the removable recording medium; and comparing the install count with the install limited count every time the software is installed, thereby controlling the installation so that the installation cannot be executed beyond the install limited count.

The medium, which is distributed by the supplier, is inserted into a recording and reading device of a computer in which the software is installed. It is possible to access the medium from the computer through the recording and reading device. In addition to the software, a start program for executing the installation is stored in a user-accessible area of the medium distributed by the supplier. The start program for executing the installation loads into the computer memory to execute the software installation in response to a start request from a keyboard, etc. The install limited count of the software, and the install count indicating the number of times the software installation has been executed, are written into a user-inaccessible area of the removable recording medium as installation management information. This prevents the installation management information from being read and written even if a user uses another tool, although the installation management information can be accessed by the installation start program.

After the installation execution program is started, the program reads the installation management information and then compares the install count with the install limited count. In this case, if the install count is smaller than the install limited count, it is determined that the installation can be executed from the distributed medium, and the process proceeds to the next step. On the other hand, if the install count is greater than or equal to the install limited count, it is determined that the software installation has already been executed the set number of times for this distributed medium. As a result, the installation is terminated. If it is determined that the installation can be executed, the installation execution program can read the main body the software from the distributed medium to install the software in a hard disk drive, which is a secondary memory device of the computer.

After that, when the installation of the software main body has been completed successfully, the installation execution program updates the install count (adds one), and then writes the information into the user-inaccessible area of the distributed medium. As a result, as compared with the install count before executing the software installation, the install count is increased by one after the installation has been completed successfully.

In addition, the installation management information, which includes the install limited count and the install count indicating the number of times the software installation has been executed, is saved in a user-inaccessible write area of the distributed medium. Therefore, the user cannot tamper with these numerical values. Moreover, even if the distributed recordable medium is illegally copied in its supplied state, the installation management information cannot be copied to a destination medium. Therefore, it is possible to detect that it is an illegally copied medium, and thereby terminate the installation.

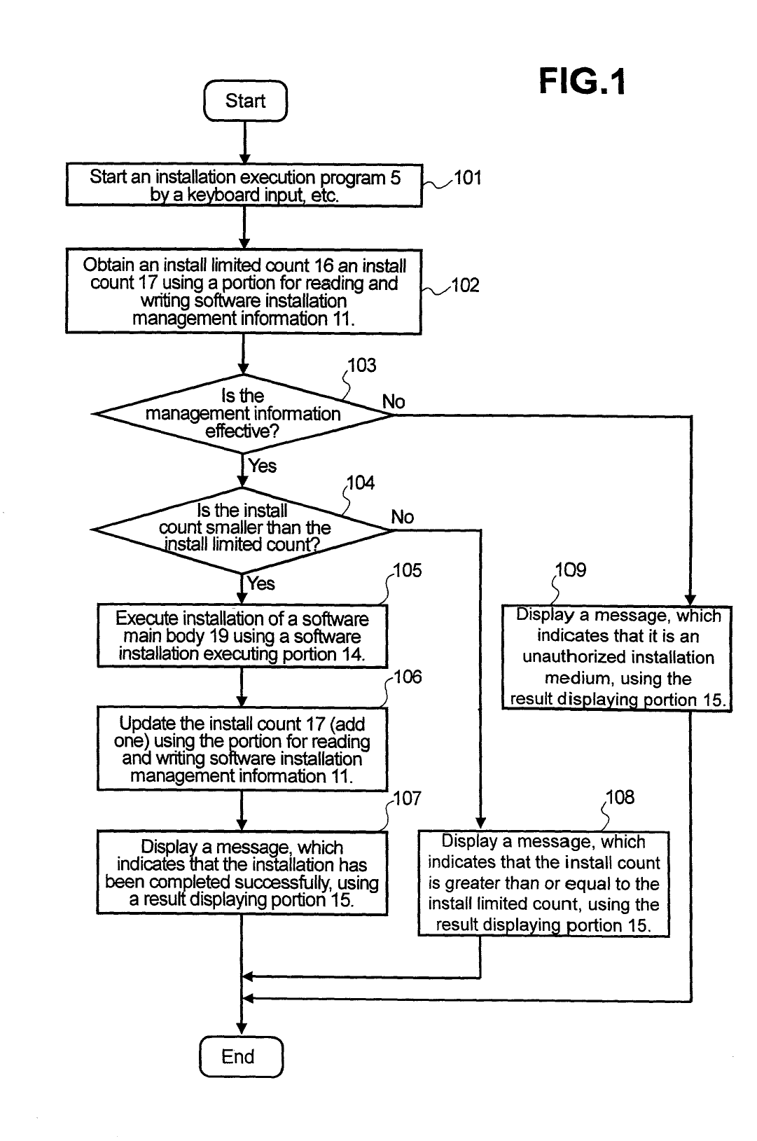

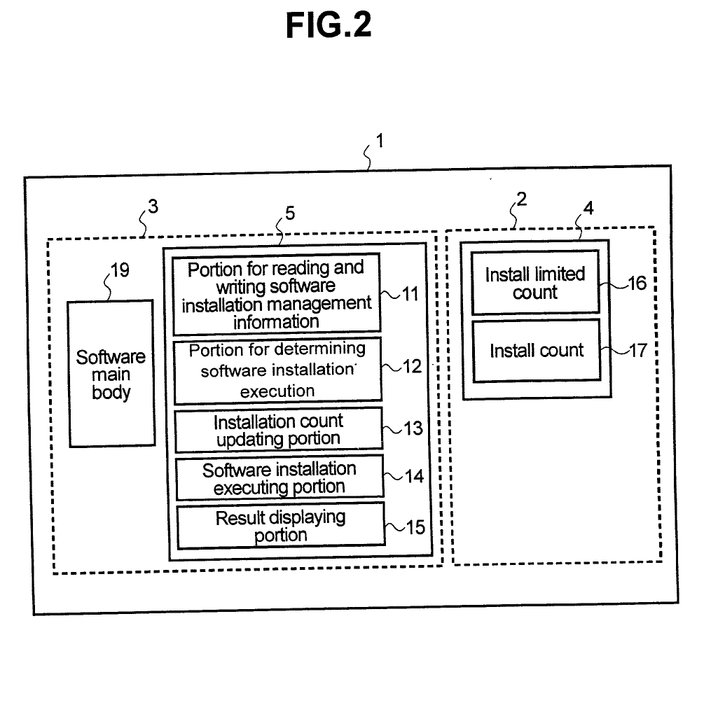

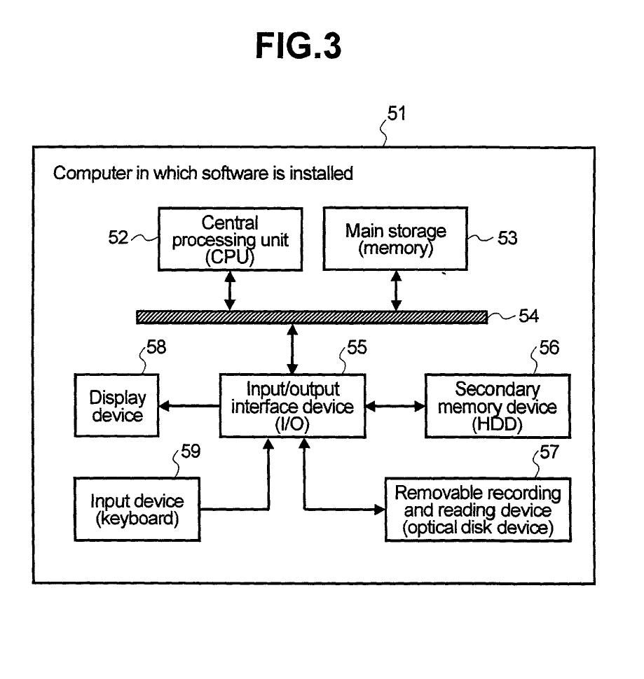

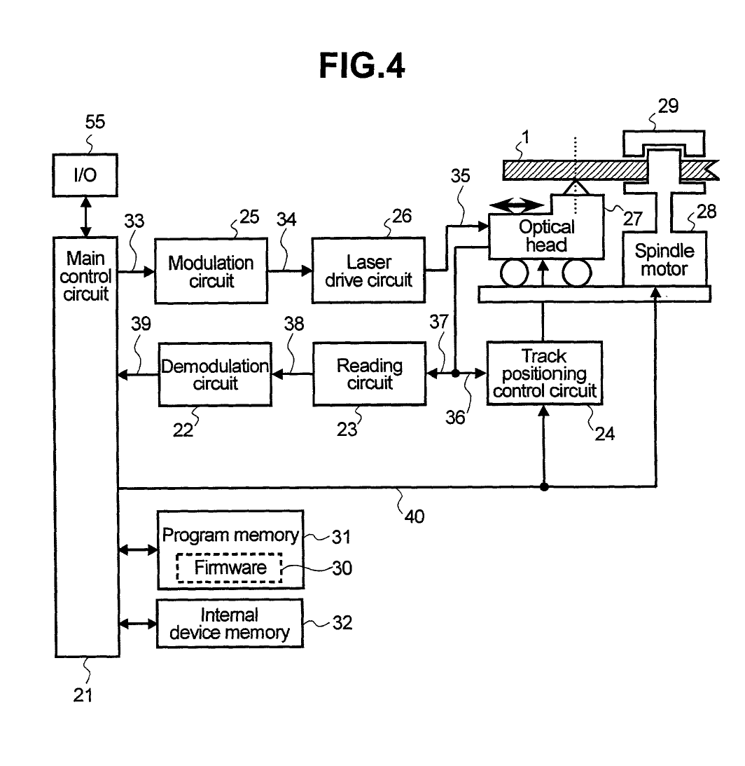

Embodiments of the present invention are now described in detail with reference to the drawings. FIG. 1 is a flowchart illustrating software installation steps according to one embodiment of the present invention. FIG. 2 is a diagram of a removable recording medium 1 distributed by a software supplier, and shows the configuration of information written onto the medium. FIG. 3 is a block diagram of an internal configuration of a computer 51 used for installing software. FIG. 4 is a block diagram of an internal configuration of a recording and reading device 57, which is implemented in computer 51 or connected to computer 51 from outside. In the embodiments described below, this recording and reading device 57 is an optical disk device; and the removable recording medium 1 (hereinafter recording medium 1) is an optical disk medium such as CD-R, CR-RW, MO, or DVD-RAM disk media.

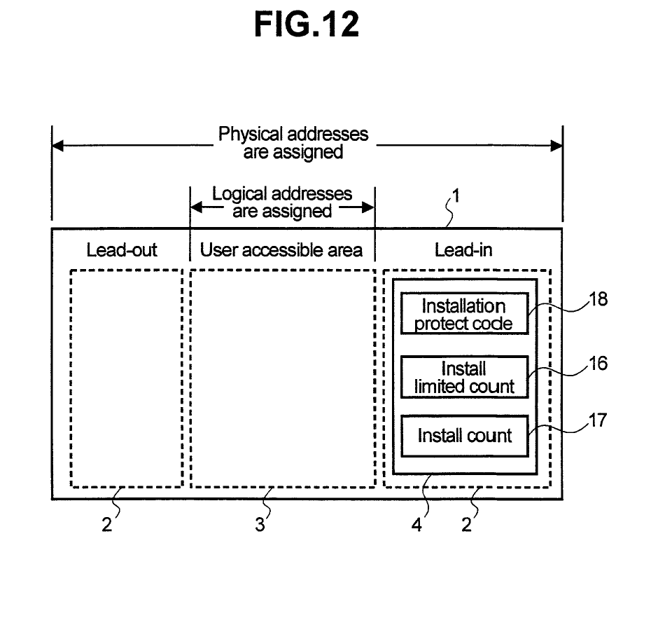

The recording medium 1 shown in FIG. 2 is distributed by a supplier for the purpose of software installation. Written information can be read by inserting the recording medium into the recording and reading device that is connected to the computer of a user. When recording medium 1 is distributed, it contains software main body 19, installation execution program 5, and installation management information 4, all of which have been written beforehand, on recording medium. Software main body 19 and installation execution program 5 are recorded on a write area 3, which can be accessed by the user; but installation management information 4 is recorded on a user-inaccessible area 2. As shown in FIG. 12, the user-inaccessible area 2 is, for example, a medium management area that exists in the inner radius of medium 1 as a “Lead-in” area, and that exists in a circumferential portion as a “Lead-out” area. In the user-inaccessible area 2, type information, format structure, change processing information, and the like, which relate to a medium, are recorded.

As shown in FIG. 12, physical addresses are assigned to all areas of the recording medium. In addition, logical addresses are assigned to user-accessible area 3, the area remaining after the lead-in area and the lead-out area are excluded from all areas. The logical address is used as an address instructed by a usual record or read command. Therefore, a user can access only user-accessible area 3, to which the logical addresses are assigned, using common commands available to users. On the other hand, user-inaccessible area 2 can be accessed only by an instruction using a physical address. Optical disk device 57 according to the present invention is designed such that a device manufacturer, a medium manufacturer, and the like, can access user-inaccessible area 2 to write and read information using test commands, which are not available to the users, for test use. Moreover, address control of the optical disk device, itself, is performed using a physical address. Therefore, as soon as a medium is inserted, a management area of the medium can be read to obtain a medium type and medium structure.

As described above, it is impossible to access the user-inaccessible area using common commands available to the users. Therefore, the user cannot perform falsification actions, such as reading and writing of the installation management information 4. Using this function, a software supplier can write the installation management information 4 into user-inaccessible area 2 by a test command. Installation management information 4 includes the following: an install limited count 16, which records the limited number of times the software installation from recording medium 1 can be executed; and an install count 17 indicating the number of times the software installation has already been executed. Install limited count 16 is determined by a contract between the software supplier and a software user before the purchase of software.

When a removable recording medium of the present invention is distributed, the medium contains install limited count 16 and install count 17 that have already been written. In the example below, install limited count 16=10, and install count 17=0 as an initial value. Every time the software installation is executed, the count value is updated (adds one). As a result, if the value of install count 17 is from 0 to 9, it is possible to install the software a total of ten times. In this embodiment, install count 17 is described as counting up. However, the install count may also be used in a countdown mode.

A write position of installation management information 4, which includes install limited count 16, install count 17, and an installation protect code 18 is now described. A block, into which management information and physical address information relating to a disk is written, is allocated in the user-inaccessible area 2 of recording medium 1. Installation management information 4 is assigned to one part of this block. If both install limited count 16 and install count 17 are two bytes in length, each of the counter values can be updated to a maximum of 65,535. This means that it is possible to execute the installation a maximum 65,535 times. As soon as recordable medium 1 is inserted, its medium management information is read in order to obtain information on the medium. Therefore, it is easy to obtain the install limited count and the install count. In addition, writing the installation protect code 18 into a predetermined position permits an optical disk device to identify this optical disk medium as a special medium for software installation.

Installation execution program 5, shown in FIG. 2, includes a portion for reading and writing software installation management information 11, a portion for determining software installation execution 12, an installation count updating portion 13, a software installation executing portion 14, and a result displaying portion 15. The portion for reading and writing software installation management information 11 is designed to enable the following: issuing a special command, which is not available to the users, to access the user-inaccessible area of recording medium 1; and reading the installation management information 4 to write new update information.

For example, the portion for reading and writing software installation management information 11 is so designed such that an access block, into which installation management information 4 is written, is predetermined outside a user area, and every time the portion for reading and writing software installation management information 11 is executed, it is possible to read and write information in the designated area. The portion for determining software installation execution 12 decides whether or not install limited count 16 and the install count 17, obtained from the portion for reading and writing software installation management information 11, are normal and effective, and thereby proceeds to the next step.

In addition, if it is determined that both counts are effective, the install limited count 16 and install count 17 values are compared and the process proceeds to the next step. When the software installation has been successfully completed, the installation count updating portion 13 updates the install count value to the count+1 (IC+1), and issues a special command, unavailable to the users, using the portion for reading and writing software installation management information 11 to write the updated counter value (IC+1) onto recording medium 1. Software installation executing portion 14 is used for installing the software main body 19 recorded on recording medium 1 in a secondary memory device 56 of the user's computer. Result-displaying portion 15 displays the state in which the software installation ends on a display device 58 of the user's computer. Since software main body 19 is usually compressed and written according to a certain algorithm, it cannot work on the recording medium 1. Software main body 19 cannot be used until installation processing is performed to decompress the software main body 19 on the computer's secondary memory device 56.

Next, a configuration of the user's computer 51 in FIG. 3, on which the software is installed, is described. Computer 51 includes the following: a central processing unit 52 (hereinafter referred to as CPU); a main storage 53 (hereinafter referred to as memory); an input/output interface device 55 (hereinafter referred to as I/O); a secondary memory device 56 (in this embodiment, a hard disk drive is used); a recording and reading device 57 comprising an optical disk device; a display device 58; and an internal bus 54 that connects an input device 59 such as a keyboard to CPU 52, memory 53, and I/O 55 in order to transfer commands and data. In FIG. 3, hard disk drive 56, recording and reading device 57, display device 58, and input device 59 are connected to I/O 55. The CPU 52, memory 53, I/O 55, hard disk drive 56, display device 58, input device 59, and internal bus 54, which are used here, are commonly used in the art; therefore, their descriptions are omitted here. Recording and reading device 57 is designed such that information can be written and read after inserting the recording medium 1 from the software supplier. It is possible to instruct memory 53 and hard disk drive 56 to call the installation execution program 5 and the software main body 19 via I/O 55 of computer 51. In addition, it is possible to write information into user-inaccessible area 2 on the recording medium 1 via I/O 55 using an installation execution program command.

In this embodiment, recording and reading device 57 is an optical disk device described in detail with reference to FIG. 4, which shows one configuration of an optical disk device 57 that reads and writes the recording medium 1 during the software installation. Optical disk device 57 includes the following: a spindle motor 28 that turns and drives the recording medium 1; an optical head 27 that writes and reads information on the recording medium 1; a main control circuit 21 for controlling the whole system in optical disk device 57; and a track positioning control system, an information recording system, and an information reading system, all of which function under main control circuit 21, and all of which are used for the optical head 27. In addition, optical disk device 57 has a medium changing unit, which is not illustrated. As soon as removable recording medium is inserted into optical disk device, the medium changing unit draws recording medium 1 to a central position of spindle motor 28 in the device, and uses a damper 29 to secure recording medium 1 to spindle motor 28. After that, the medium changing unit rotates recording medium 1 up to the given number of revolutions using spindle motor 28. After recording and reading are completed, an external instruction causes the medium changing unit to eject the recording medium 1 from optical disk device 57.

Next, optical head 27 is positioned at a track position, as instructed by I/O 55, using the track positioning control system. The required data regarding position information 40 and current position information 36 read by optical head 27 are transmitted to track positioning control circuit 24. The track positioning control circuit drives the optical head radially across the disk.

The information recording system converts recording information 33 transmitted from I/O 55 into an information code 34, which is written, using a modulation circuit 25. The writing information code is input into a laser drive circuit 26, where the writing information code is converted into a driving electric current 35 in response to a writing pattern and then the driving electric current 35 is transmitted to the optical head 27. In the optical head 27, the driving electric current 35 is converted into an optical pulse by a laser driver and a semiconductor laser, which are not illustrated. After that, the optical pulse is irradiated on a surface of a recording film of the recording medium 1 to write information.

In the information reading system, the optical head 27 emits laser light to irradiate the recording film surface or a surface of a read-only film, and thereby reads information. A reading signal 37 from the optical head 27 is identified in a reading circuit 23 to obtain a reading information code 38. Reading information code 38 becomes reading information 39 in a demodulation circuit. After that, the reading information is transmitted to I/O 55 via main control circuit 21.

Main control circuit 21 includes a central processing unit such as a microcomputer, which is not illustrated and a data buffer that temporarily stores writing and reading information for recording medium 1. Main control circuit 21 controls the track positioning control system, the information recording system, and the information reading system; and reads and writes information according to a command from I/O 55. In addition, a program memory 31 and an internal device memory 32 are connected to the main control circuit. Program memory 31 comprises a rewritable ROM for storing firmware 30 of a microcomputer, which is the main control circuit 21 of optical disk device 57. Internal device memory 32 comprises a RAM for storing various data that is used by the main control circuit.

Next, the steps of a software installation method according to the present invention will be described with reference to FIG. 1. Software installation becomes possible when recording medium 1 is inserted into optical disk device 57 so that information can be read. In step 101, when a user starts installation execution program 5 using input device 59, such as a keyboard, the optical disk device reads the program into memory 53 on computer 51. In step 102, installation execution program 5 executes the portion for reading and writing software installation management information 11, and thereby issues a special command, not available to users, to read installation management information 4 from user-inaccessible area 2 on recording medium 1. This command is transferred to optical disk device 57 through I/O 55 in computer 51. Optical disk device 57 reads installation management information 4. However, since the information is not displayed on display device 58, the information is not known to the users.

In step 103, the portion for determining software installation execution 12 checks the data for install limited count 16 and install count 17 in installation management information 4, and determines whether the values are correct. If the removable recording medium is illegally copied, installation management information 4 will not copy. Therefore, even if an installation is performed with an illegally copied removable recording medium, that recording medium can be deemed an unauthorized installation medium. In step 109, if an illegally copied medium is used, result-displaying portion 15 of installation execution program 5 sends a message indicating that installation is being executed by an unauthorized installation medium, and the message is displayed on display device 58 before the software installation is forced to terminate.

In step 104, as in step 103, the portion for determining software installation execution 12 compares install count 17 with install limited count 16. In this case, if the install count is smaller than the install limited count, it is determined that installation by recording medium 1 is allowed, and the process proceeds to step 105. On the other hand, if the install count is greater than or equal to the install limited count, it is determined that the software installation has already been executed the set number of times for this distributed medium. In step 108, if the installation has already been executed the set number of times, result displaying portion 15 of installation execution program 5, sends a message to display device 58, indicating that installation cannot be executed because the set number of installations has already been reached. After that, the software installation is forced to terminate.

Step 105 is performed when it is determined that the installation can be executed. Software installation executing portion 14 of installation execution program 5 reads software main body 19 from recording medium 1. Software 19 can be installed in a secondary memory device 56, such as a hard disk drive, in computer 51. When the installation of the software main body described above has been successfully completed, installation execution program 5, at step 106, uses installation count updating portion 13 to update install count 17 (in this case, adding one). Then, using the portion for reading and writing software installation management information 11, installation execution program 5 issues a special command, unavailable to the users, to write the updated install count 17 (IC+1) into the user-inaccessible area of recording medium 1. In step 107, using result displaying portion 15 of installation execution program 5, a message is sent to display device 58 indicating that the installation has been successfully completed.

Performing the steps described above permits the software to be installed in computer 51, and installations can be limited within the set number of times authorized by the supplier. In addition, because installation management information 4 including both install limited count 16 of the software and install count 17 is saved in user-inaccessible writing area 2 on the distributed medium, the user cannot tamper with these numerical values. Moreover, even if recording medium 1 is copied in its supplied state, installation management information 4 cannot be copied to the illegally copied medium. Therefore, it is possible to detect an illegally copied medium, and to terminate the installation.

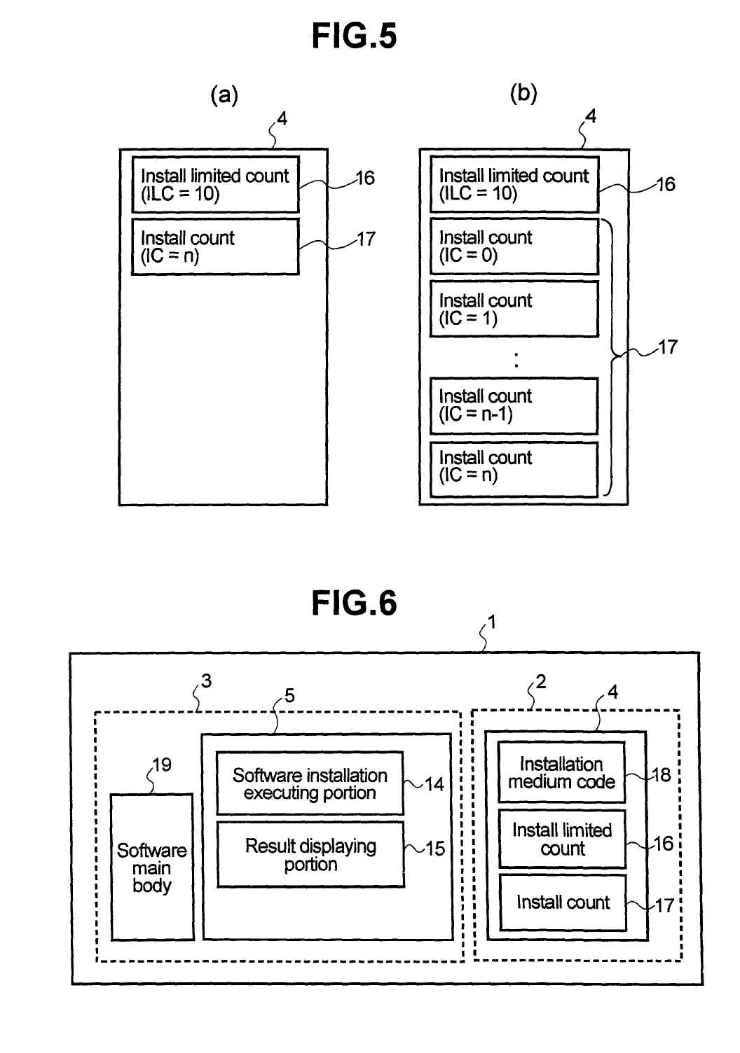

A method for writing the install count 17, which indicates the number of times the software stored on recording medium 1 has been installed, is now described with reference to FIGS. 5(a)-(b). The recording method differs to some degree according to the type of recording medium. As one example, if a rewritable recording medium 1 is used, installation management information 4 is as illustrated in FIG. 5(a). Every time the software installation is executed, its install count 17, is updated (by adding one). In the case of the rewritable medium, the recorded area may be overwritten. On the other hand, if a write-once recording medium, which cannot be overwritten, is used, installation management information 4 is as illustrated in FIG. 5(b). Since a recorded area cannot be overwritten, every time the software installation is executed, install count information is updated (by adding one), and then is written into the next area in succession. As a result, the newest install count 17 is recorded as the last information that has been written in succession. The portion for determining software installation execution 12 may use this newest install count 17 in the processing steps described above.

The removable recording medium 1 is a writable medium. Therefore, in order to prevent the software main body 19 to be installed from being rewritten or destroyed as a result of writing to a user-accessible area, owing to carelessness of the user, or the like, it is also possible to prevent writing to user-accessible area 3 of recording medium 1. This method is not illustrated. However, for example, the following method: provides a cartridge of recording medium 1 with a slide tab for switching between writable and write-protect; and detecting this when recording medium 1 is inserted into optical disk device 57. However, writing information to user-inaccessible area 2 is always possible.

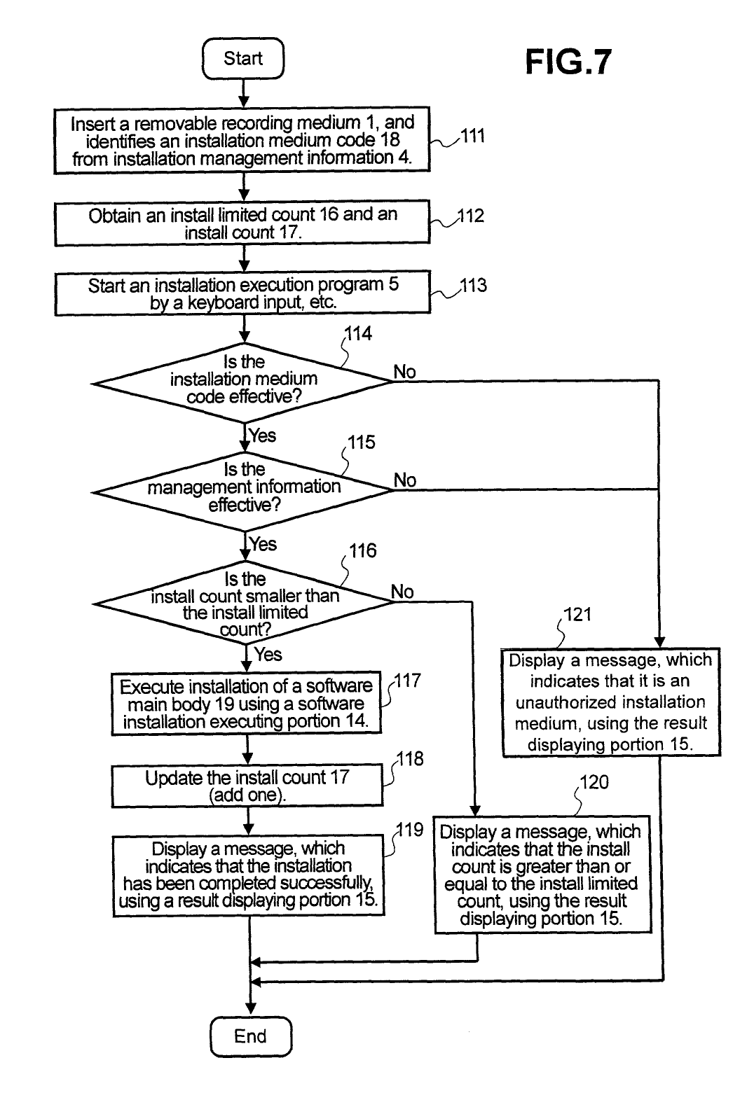

In the software installation according to the present invention, it is not possible to install the software more than the number of times pre-authorized by the software supplier. However, a case can arise where a malicious user tampers with the installation execution program that resides in memory 53 on computer 51, in order to hinder normal operation of the portion for reading and writing software installation management information 11, the portion for determining software installation execution 12, and the installation count updating portion 13, with the result that the installation is executed more than the number of times pre-authorized by the software supplier. This can occur because the function of determining the limitation of the install count, also resides in memory 53 of computer 51. An exemplary configuration of an embodiment described below is designed to prevent the installation execution program from being tampered with, by removing the function of determining limitation of the install count from the installation execution program, and putting the function in the program memory 31 of the optical disk device 57. This is now described in detail with reference to FIGS. 6 and 7.

When recording medium 1 shown in FIG. 6 is distributed, software main body 19, installation execution program 5, and installation management information 4 have been written beforehand on the recording medium. Of these, the software main body and the installation execution program are recorded in writing area 3, which can be accessed by the user; and the installation management information is recorded in user-inaccessible area 2. Installation management information 4 includes installation protect code 18, which indicates that removable recording medium 1 is a software installation medium; install limited count 16, which records the limited number of times the software installation can be executed; and install count 17, which indicates the number of times the software installation has already been executed. The install limited count and the install count are the same as those described above with reference to FIG. 1. Installation protect code 18 is a special code indicating that recording medium 1 has been made for software installation, and was written by the supplier before being distributed. Providing this installation protect code 18 permits install limited count 16 and install count 17 to be located in main control circuit 21 of optical disk device 57, and also enables the determination of installation function to execute in that same main control circuit.

Installation execution program 5 takes charge of execution of a software installation method according to the present invention and includes software installation-executing portion 14 and result-displaying portion 15. The software installation-executing portion 14 is used for installing software main body 19, which is recorded on recording medium 1, on hard disk drive 56 of the user's computer. Result-displaying portion 15 displays the state in which the software installation ends, on display device 58 of user's computer 51. Since the software main body 19 is usually compressed and written according to certain algorithm, it cannot work on the removable recording medium. The software main body 19 cannot be used until installation processing is performed to decompress the software main body 19 in the secondary memory device 56 in the user's computer.

Next, a software installation method according to the present invention will be described with reference to the flowchart shown in FIG. 7. In step 111, as soon as recording medium 1 is inserted into optical disk device 57, the optical disk device identifies the installation medium. In this case, since the installation protect code 18 was recorded in advance as a medium identification code on the recording medium 1, step 112 is automatically executed. In step 112, optical disk device 57 reads installation management information 4, which is recorded in the user-inaccessible area 2 on recording medium 1, and then stores that information in internal device memory 32. When a user starts the installation execution program 5 in step 113 using an input device 59 such as a keyboard, steps 114, 115, and 116, which will be described below, are executed in succession in optical disk device 57. In step 114, a determination is made whether or not the obtained medium identification code is the proper installation protect code 18. If it is not the proper installation protect code 18, the medium is deemed an unauthorized installation medium, and, in step 121, the result of step 114 is displayed on display device 58 before the software installation terminates.

In step 115, in the optical disk device 57, a determination is made whether or not install limited count 16 and install count 17 recorded in the installation management information 4 are correct. Because install limited count 16 was written before the software installation medium was supplied, it is possible to detect falsification if the medium has been tampered with. For example, if recording medium 1 is copied illegally to execute installation using an illegal copy, removable recording medium 1′, installation management information 4 does not exist in the illegally copied medium. Because of this omission, the removable recording medium 1′ can be deemed an illegally copied medium. Suppose that the illegally copied medium 1′ is used in step 121: result displaying portion 15 of installation execution program 5 sends a message, displayed on display device 58, indicating that the attempted installation is using an unauthorized installation medium. After that, the software installation is terminated.

In step 116, install limited count 16 and install count 17, which are stored in internal device memory 32, are compared with each other in main control circuit 21. In this case, if the install count 17 is smaller than install limited count 16, installation by recording medium 1 is allowed, and the process proceeds to step 117. On the other hand, if install count 17 is greater than or equal to install limited count 16), it is determined that the software installation has already been executed the set number of times for this distributed medium. In step 120, if it is determined that the installation has already been executed the set number of times, result displaying portion 15 of installation execution program 5 sends a message, displayed on display device 58, the installation has already been executed the set number of times. After that, the software installation is forced to terminate.

Step 117 is performed when it is determined that an installation can be executed. Software installation executing portion 14 of installation execution program 5 reads the software main body 19 from recording medium 1. Software main body 19 can be installed in secondary memory device 56, such as a hard disk drive, in the user's computer 51. In step 118, when the installation of the software main body has been successfully completed, optical disk device 57 updates install count 17 (in this case, adds one), and then writes the updated install count (IC+1) into the user-inaccessible area 2 of recording medium 1. As a result, when compared with the pre-installation install count the post-installation install count has been increased by one. In step 119, result displaying portion 15 of installation execution program 5 sends a message, displayed on display device 58, indicating that the installation has been successfully completed.

Performing the steps described above permits the software to be installed in the user's computer 51 and the install count to be updated so that installations cannot exceed the set number authorized by the supplier. In this case, install limited count 16 of the software, and install count 17 indicating the number of times the software installation has been executed, are located in optical disk device 57. In addition, the determination, using these values, of whether or not the installation is allowable is also made in optical disk device 57. Therefore, it is possible to provide an installation method that can prevent tampering with the installation execution program.

The software described above mainly includes application software and an operation system, which are installed in hard disk drive 56 in the user's computer 51. A method for rewriting (updating) firmware of a writing and reading device is described below. For example, in the case of optical disk device 57, described above, firmware for the recording and reading device is required for executing the main control circuit 21 that controls processing by the device. The firmware usually exists in program memory 31 inside the device. Sometimes, after shipment of the recording and reading device, the firmware may need to be changed because of a malfunction in operation, or to improve functions and performance. An update for a minor change may be obtained free of charge. However, if a major function is added (for example, a support medium is added, or the like), or if performance is significantly improved, or in other cases, the update may be distributed for a fee. For these reasons, when firmware for the recording and reading device is supplied, and a firmware update is executed without limitation, the distribution for pay becomes worthless. Therefore, as in the case of application software, a firmware installation method (an updating method) having a function that limits the number of allowable installations is advantageous.

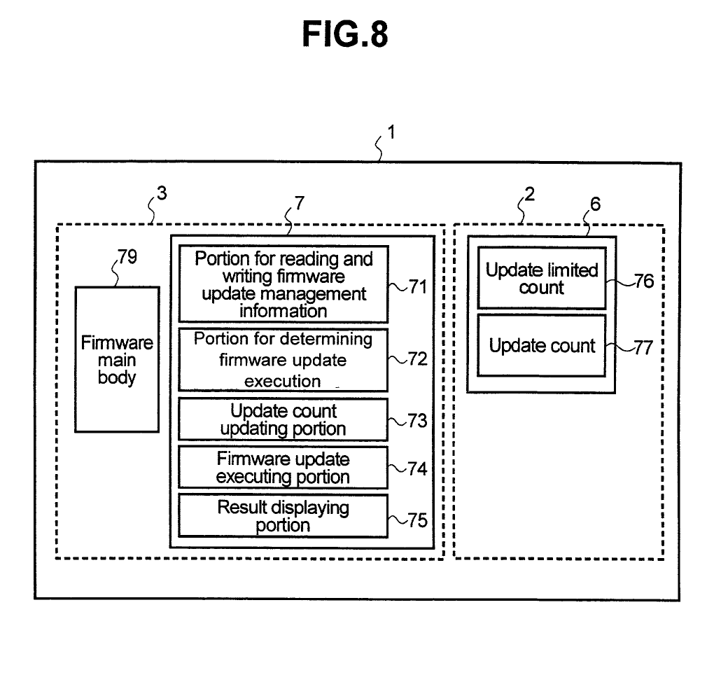

With reference to FIGS. 4 and 8, the following are now described: a firmware updating method by which the currently used firmware 30 in program memory 31 of optical disk device 57, according to the present invention, is replaced with new firmware 79 written on recording medium 1; and an optical disk device that uses the firmware updating method.

As shown in FIG. 4, rewritable program memory 31 and internal device memory 32 are connected to main control circuit 21. Program memory 31 stores firmware 30 of a microcomputer, which is the main control circuit 21, and controls the optical disk device.

Removable recording medium 1, shown in FIG. 8, is distributed by a device supplier for the purpose of firmware update. Recording medium 1 can be written and read using optical disk device 57. The functions and features of the firmware/update aspect of the invention are the same as those described above for the software/installation embodiment.

As shown in FIG. 8, when recording medium 1 is distributed, it contains firmware main body 79, update execution program 7, and update management information 6, written beforehand by the supplier. The firmware main body and the update execution program are recorded in a user-accessible writing area 3, and the update management information is recorded in a user-inaccessible area 2. Update management information 76 includes the following: an update limited count 76, which records the limited number of times the firmware update from this removable recording medium can be executed; and an update count 77 indicating the number of times the firmware update has already been executed. The updated limited count is determined by a contract between the firmware supplier and a user before purchase. When recording medium 1 is distributed, it contains both the update limited count 76 and the update count 77 written by the supplier prior to distribution. Update count 77 has been assigned an initial value of 0, and each time the firmware update is executed, the count value is updated (by adding one).

Update execution program 7, shown in FIG. 8, takes charge of a firmware updating method according to the present invention. Update execution program 7 comprises a portion for reading and writing firmware update management information 71, a portion for determining firmware update execution 72, an update count updating portion 73, a firmware update executing portion 74, and a result displaying portion 15. The portion for reading and writing firmware update management information 71 is designed to enable the following: issuing a special command, unavailable to the users, to access the user-inaccessible area of removable recording medium 1; and reading update management information 6 to write new update information. For example, the portion for reading and writing firmware update management information 71 is designed such that an access block, into which update management information 6 is written, is predetermined outside a user area, and every time the portion for reading and writing firmware update management information 71 is executed, it is possible to read and write information in the area.

The portion for determining firmware update execution 72 determines whether update limited count 76 and update count 77, which have been obtained by the portion for reading and writing firmware update management information 71, are normal and effective, and thereby decides whether to proceed with the update. As is the case with the software installation in computer 51, the decision can be made by checking whether or not update limited count 76 data and update count 77 data exist. If these data are found and both counts are deemed effective, update limited count 76 and update count 77 are compared with each other, and the update proceeds. When the firmware update has been successfully completed, update count updating portion 73 updates the update count value (UC) (UC+1), and issues a special command, unavailable to the users, using the portion for reading and writing firmware update management information 71 to write the updated value into recording medium 1. Firmware update executing portion 74 stores firmware main body 79, which is recorded in recording medium 1, in program memory 31 inside optical disk device 57. Result-displaying portion 75 displays the state in which the firmware update ends on display device 58 of computer 51.

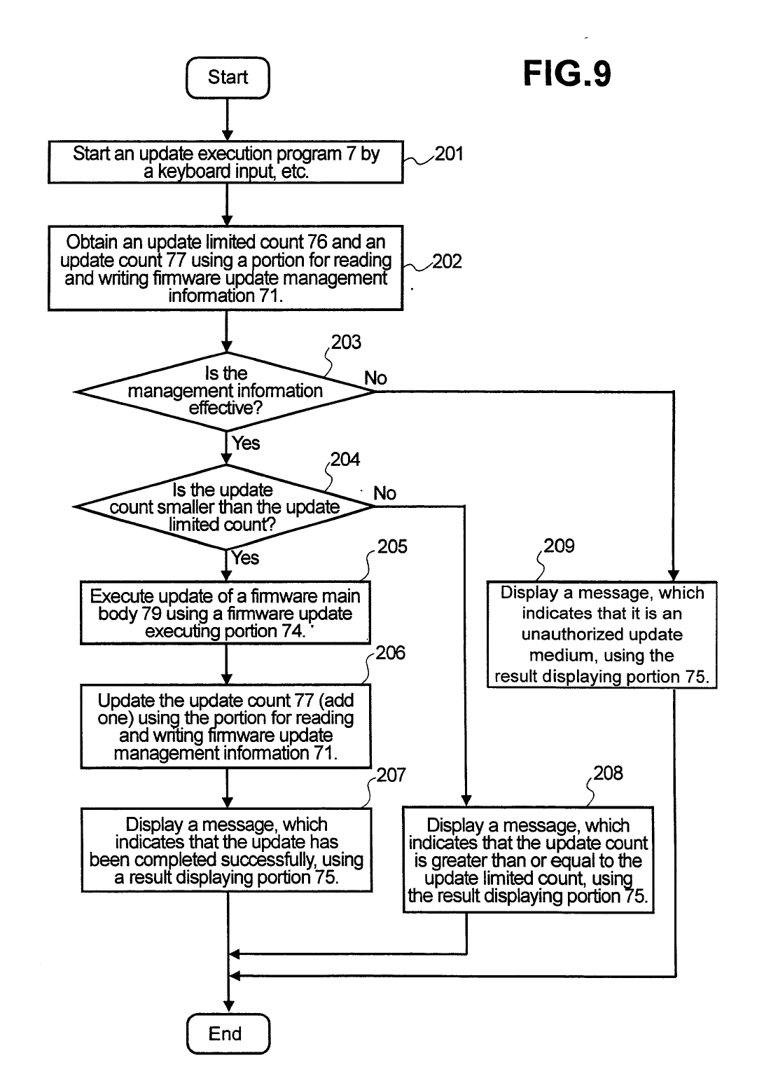

Next, a firmware updating method according to the present invention will be described with reference to the flowchart in FIG. 9, as well as the drawings of FIGS. 3 and 8. Software installation becomes possible when removable recording medium 1 is inserted into optical disk device 57 so that information can be read. In step 201, when a user starts update execution program 7 using input device 59—such as a keyboard—the program is read into memory 53 on computer 51. In step 202, update execution program 7 executes the portion for reading and writing firmware update management information 71, thereby issuing a special command, unavailable to the users, to read update management information 6 in the user-inaccessible area 2 on recording medium 1. This command is transferred to optical disk device 57 through I/O 55 in computer 51. Optical disk device 57 reads the update management information 6, but because the information is not displayed on display device 58, the information is not known to the users.

In step 203, the portion for determining firmware update execution 72 determines whether update limited count 76 and update count 77, in the update management information obtained in step 202, are correct. Because the update limited count 76 (ULC) was written before a firmware update medium was supplied, falsification can be detected if tampering has occurred. For example, if removable recording medium 1 is copied illegally to execute an update using an illegal copy, removable recording medium 1′, the update management information 6 does not exist in illegally copied medium 1′. Thus, removable recording medium 1′ can be deemed an unauthorized update medium.

At step 209, if the illegally copied medium is used, result displaying portion 75 of update execution program 7 sends a message indicating that update is being executed by an unauthorized medium, and the message is displayed on display device 58 before the update is forced to terminate. Next, in step 204, the portion for determining firmware update execution 72 compares update count 77 with update limited count 76. In this case, if update count 77 is smaller than update limited count 76, update by recording medium 1 is allowed, and the process proceeds to step 205. If, however, update count 77 is greater than or equal to update limited count 76, the firmware update is determined to have already been executed the set number of times for this recording medium, and in step 208, the result displaying portion 75 of the update execution program 7 sends a message, displayed on display device 58, indicating that the update cannot be executed because the set number of updates has already been executed. After that, the update is forced to terminate.

At step 205 the update is executed. Firmware update executing portion 74 of update execution program 7 issues an update command to optical disk device 57, and main control circuit 21 moves a part of the firmware, which relates to recording and reading recording medium 1, from program memory 31 to internal device memory 32. Thereafter, processing is performed using the firmware that has been moved into device memory 32. Program memory 31 is freed for storage of new firmware. This prevents a failure during the update. Main control circuit 21 reads firmware main body 79 from recording medium 1, then stores firmware main body 79 in program memory 31 of the optical disk device.

In step 206, when the updating of firmware 79 has been successfully completed, update execution program 7, using update count updating portion 73, updates the update count 77 (in this case, adds one). Then, using the portion for reading and writing firmware update management information 71, update execution program 7 issues a special command, unavailable to the users, to write updated update count 77 (UC+1) into user-inaccessible area 2 of recording medium 1. When the current count is then compared with the previous count, update count 77 is shown to have increased by one. In step 207, result displaying portion 75 of the update execution program, sends a message, shown on display device 58, that the update has been successfully completed.

Performing the steps described above permits optical disk device 57 to update the firmware. In addition, by writing the number of times the firmware update has been executed as update count 77 on recording medium 1, and by comparing update count 77 with update limited count 76, updates can be limited to the set number authorized by the supplier. Moreover, the update management information, which includes update limited count 76 and update count 77, is saved in a user-inaccessible writing area on the distributed medium. Therefore, the user cannot tamper with these numerical values. Moreover, even if removable recording medium 1 is copied in its supplied state, the update management information cannot be copied to the illegal copy. Therefore, it is possible to detect an illegal copy, and thereby to terminate the update.

As is the case with the software installation method, for the purpose of preventing the update execution program, which resides in memory 53 inside computer 51, from being tampered with, optical disk device 57 can be provided with the function of determining the limitation of the update count. The components for this function include the portion for reading and writing firmware update management information 71, the portion for determining firmware update execution 72, and the update count updating portion 73.

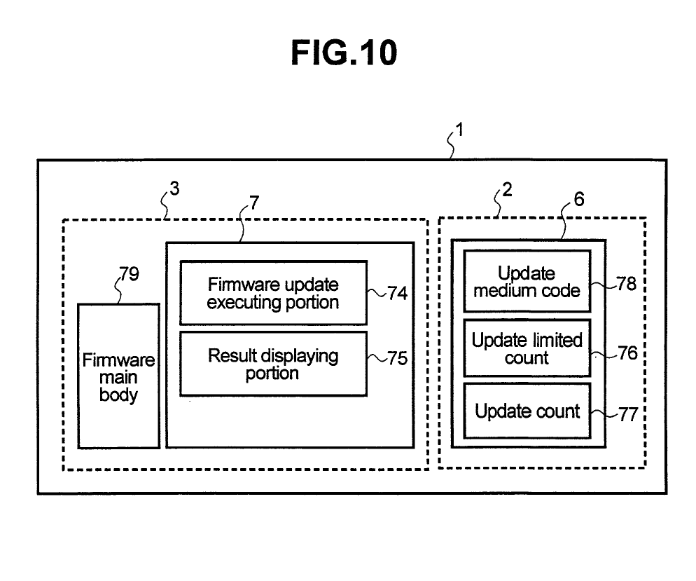

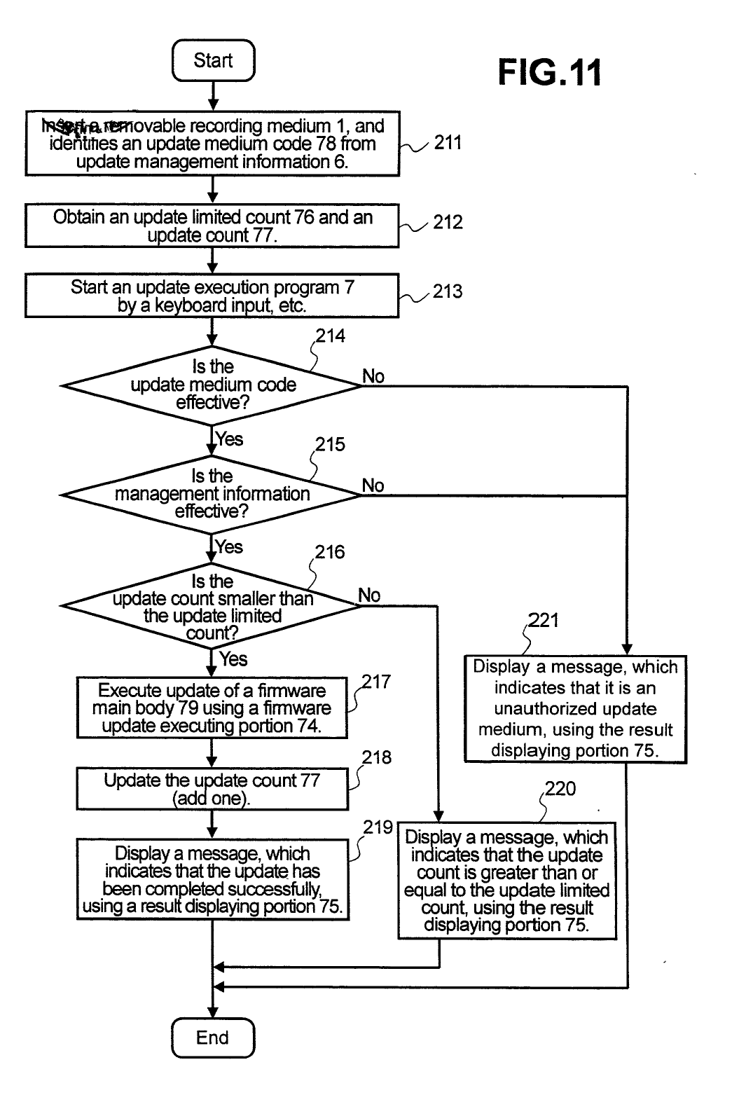

The firmware updating method is described with reference to FIGS. 10 and 11, which are analogous to software installation FIGS. 6 and 7. The terms “software” and “installation,” used in FIGS. 10 and 11, are replaced with the terms “firmware” and “update,” respectively, in FIGS. 10 and 11. A point of difference is that when firmware update executing portion 74 of the update execution program issues an update command to optical disk device 57, main control circuit 21 moves the part of firmware, which relates to recording and reading recording medium 1, from program memory 31 to internal device memory 32, and thereafter processing is performed using the firmware moved into device memory 32. This move frees program memory 31 to store new firmware and prevents a failure during the update.

According to the flowchart of FIG. 11, the firmware is updated to the latest version. In addition, by writing the number of times the update has been executed as update count 77 on recording medium 1, updates can be limited to the set number authorized by the supplier. In this case, update limited count 76 and update count 77 reside in the optical disk device 57, and the function using these values to determine whether to allow an update also resides in optical disk device 57. Therefore, it is possible to provide a firmware update method that can prevent the update execution program from being tampered with.

Another method to prevent tampering with the updated execution program comprises the steps of omitting update execution program 7 on recording medium 1 (shown in FIG. 10), storing this function in program memory 31 of optical disk device 57. and executing the firmware update in main control circuit 21. To be more specific, by identifying an update medium code 78 in update management information 6, optical disk device 57 automatically executes steps 211, 212, 214, 215, 216, 217 and 218 in FIG. 11 without being instructed by computer 51. Because step 213 is used to start the update with an I/O device, omitting step 213 will produce no problem if the processing is performed in succession. In this case, even if the computer 51 is not connected, the firmware can be updated. In addition, this method does not require user operation. Therefore, this method greatly simplifies the update using a configuration having only optical disk device 57 and removable recording medium 1.

Although all of the embodiments described above use a removable recording medium as the optical disk medium, and an optical disk device as the recording and reading device, the present invention is not limited to the one medium or device. In other words, the present invention can also be embodied in the same manner using a magnetic disk medium, a flexible disk medium, and the like. Even if instead of a disk medium, a solid-state memory such as a semiconductor is used, which is driven mechanically for scanning, like various kinds of media, providing an information storing area with a user-accessible area and a user-inaccessible area permits the present invention to be applied. In addition, the optical disk medium is a generic name that includes write-once-read-many optical disk media, magneto-optical recording media, phase-change recording media, and dye polymer recording media. In the embodiment described above, the installation execution program is recorded on one removable recording medium. However, this program may be supplied using another medium as long as the program is created so that it operates as one united body.

The software installation and the firmware update in the embodiments described above do not require an environment, such as connection to a host computer, except a computer for an installation or a recording and reading device for an update. Even an independent environment enables the software installation and the firmware update.

Using the embodiments according to the present invention described above, when installing software in a computer, or the like, it is possible to prevent software from being installed in a computer more than the number of times authorized by a software supplier. Moreover, even if a supplied recording medium is illegally copied, installation from the copied medium cannot be executed. Therefore, it is possible to prevent unauthorized use.

While the above is a description of exemplary specific embodiments of the invention, additional embodiments are also possible without departing from the scope of the invention, which is defined by the appended claims along with their full scope of equivalents.

What is claimed is:

1. A recording medium, comprising:
an area in which software to be installed in a computer is recorded; and
a user-inaccessible area where an install limited count, which indicates the number of times software installation is allowed, is written beforehand, and where an install count, which is updated every time the software installation is executed, is recorded.

2. A recording medium according to claim 1, on which an installation execution program is additionally recorded, said installation execution program comprising:
a portion for determining software installation execution, which compares the install count with the install limited count; and
an installation execution portion for executing installation of the software in a computer if the install count is smaller than the install limited count.

3. A recording medium according to claim 2, wherein the installation execution program comprises a result displaying portion by which as a result of the decision made by the portion for determining software installation execution, if the install count is greater than or equal to the install limited count, a message is displayed indicating that installation is not allowed.

4. A recording medium according to claim 1, wherein the area, in which the software is recorded, is a recordable medium on which a user can write data.

5. A recording and reading device, by which according to a request for software installation from an outside device, the software is read from a recording medium on which the software is recorded, and then the software is output to the outside device, said recording and reading device comprising:
an optical pickup for reading an install count indicating the number of times the software has been installed, and an install limited count indicating the number of times the installation is allowed, which have been written beforehand in a user-inaccessible area of the recording medium; and
a main control circuit for determining whether or not the install count is smaller than the install limited count;
wherein if the install count is smaller than the install limited count, the optical pickup reads the software from the recording medium; and
every time the software is installed in the outside device, the optical pickup updates the install count, and then writes the install count into a user-inaccessible area of the recording medium.

6. A recording and reading device, comprising:
an optical pickup for reading information recorded on the recording medium according to claim 1, and for recording information on the recording medium;
a program memory that stores an installation execution program for executing installation of software recorded on the recording medium; and
a main control circuit for controlling the optical pickup and the program memory;
wherein the main control circuit executes the installation execution program stored in the program memory, controls the optical pickup so that the install limited count and go the install count are read, and compares the install count with the install limited count; and
if the install count is smaller than the install limited count, the main control circuit reads the software to be installed from the recording medium, controls the optical pickup so that the install count recorded on the recording medium is updated, and outputs the read software to the outside of the recording and reading device.

7. A recording and reading device, comprising:
a recording and reading means for reading information recorded on the recording medium according to claim 1, and for recording information on the recording medium;
a program memory that stores an installation execution program for executing installation of software recorded on the recording medium; and
a main control circuit for controlling the recording and reading means and the program memory;
wherein the main control circuit executes the installation execution program stored in the program memory, controls the recording and reading means so that the install limited count and the install count are read, and compares the install count with the install limited count; and
if the install count is smaller than the install limited count, the main control circuit reads the software to be installed from the recording medium, controls the recording and reading means so that the install count recorded on the recording medium is updated, and outputs the read software to outside of the recording and reading device.

8. A recording and reading device, comprising:
a recording and reading means for reading information recorded on the recording medium according to claim 1, and for recording information on the recording medium;
a program memory that stores an installation execution program for executing installation of software recorded on the recording medium; and
a main control circuit for controlling the recording and reading means and the program memory;
wherein the main control circuit executes the installation execution program stored in the program memory, controls the recording and reading means so that the install limited count and the install count are read, and compares the install count with the install limited count; and
if the install count is greater than or equal to the install limited count, the main control circuit outputs a signal, which indicates that installation is not allowed, to the outside of the recording and reading device.

9. A software installation method for installing software in a storage device from a recording medium, on which the software to be installed in a computer is recorded, said recording medium having a user-inaccessible area where an install limited count, which indicates the number of times the software installation is allowed, is recorded, and where an install count, which is updated every time the software installation is executed, is recorded, said software installation method comprising the steps of:
comparing the install count with the install limited count; and
if the install count is smaller than the install limited count, installing the software in the storage device.

10. A software installation method according to claim 9, wherein:
if the install count is greater than or equal to the install limited count, a user is informed that the software cannot be installed in the storage device.

11. A computer, comprising:
a recording and reading device that can read information recorded on the recording medium according to claim 2;
a main storage for temporarily storing the installation execution program, which has been read by the recording and reading device;
a secondary memory device for storing the software to be installed; and
a central processing unit for controlling the recording and reading device, the main storage, and the secondary memory device;
wherein the central processing unit executes the installation execution program stored in the main storage, and compares the install count with the install limited count; and
if the install count is smaller than the install limited count, the central processing unit reads the software to be installed from the recording medium, controls the recording and reading device so that the install count recorded on the recording medium is updated, and controls the secondary memory so that the read software is stored.

12. A computer according to claim 11, further comprising:
a display device for displaying a result of installation;
wherein if the install count is greater than or equal to the install limited count, the main storage terminates the installation, and then the display device displays a message indicating that the installation is not allowed.

13. A recording medium, comprising:
an area in which a second firmware for updating a first firmware is recorded, the first firmware being possessed by a recording and reading device for reading information recorded on the recording medium, and for recording information on the recording medium; and
a user-inaccessible area where an update limited count, which indicates the number of times the firmware update is allowed, is written beforehand, and where an update count, which is updated every time the firmware update is executed, is recorded.

14. A recording and reading device, comprising:
an optical pickup for reading information recorded on the recording medium, and for recording information on the recording medium; and
a program memory having a first firmware that controls reading and recording of the information;
wherein the optical pickup reads an update count and an update limited count from a recording medium, on which a second firmware for updating the first firmware is recorded, said recording medium having a user-inaccessible area where the update count, which indicates the number of times the update has been executed, is written beforehand, and where the update limited count, which indicates the number of times the update is allowed, is written beforehand;
if the update count is smaller than the update limited count, the optical pickup reads the second firmware from the recording medium; and
when the first firmware in the program memory is updated to the second firmware, the optical pickup updates the update count, and then writes the update count into the user-inaccessible area of the recording medium.

15. A firmware updating method for updating a first firmware to a second firmware in a storage device by reading the second firmware from a recording medium, on which the second firmware for updating the first firmware is recorded, said recording medium having a user-inaccessible area where an update limited count, which indicates the number of times the firmware update is allowed, is recorded, and where an update count, which is updated every time the firmware update is executed, is recorded, the first firmware being possessed by a recording and reading device for reading information recorded on the recording medium, and for recording information on the recording medium, said firmware updating method comprising the steps of:
comparing the update count with the update limited count; and
if the update count is smaller than the update limited count, updating the first firmware to the second firmware in the storage device.
